(19) United States
(12) Patent Application Publication
(10) Pub. No.: US 2026/0212316 A1
(43) Pub. Date: Jul. 23, 2026

(54) SYSTEMS AND METHODS FOR DYNAMIC AND INTELLIGENT INVENTORY MANAGEMENT

(71) Applicant: Wells Fargo Bank, N.A., San Francisco, CA (US)

(72) Inventors: Michelle L. Mercado, Las Vegas, NV (US); Janet L. Koger-Nowlin, Charlotte, NC (US); Susan J. Luehrs, Los Angeles, CA (US); Melissa Ann Kubasta, Saint Paul, MN (US)

(21) Appl. No.: 19/034,233

(22) Filed: Jan. 22, 2025

(51) Int. Cl. G06Q 10/087

(52) U.S. Cl. CPC G06Q 10/087

(57) ABSTRACT

Systems, apparatuses, methods, and computer program products are disclosed for automation of an inventory management system. An example method includes detecting a transaction associated with a configured entity account. The example method further includes identifying a product identifier associated with the transaction. The example method further includes determining, based on the product identifier, a new stock quantity for an offering associated with the configured entity account, wherein the offering is at least one of a product category, a product, and a product component. The example method further includes causing an inventory management database to be updated to reflect the new stock quantity for the offering, wherein the configured entity account is linked to the inventory management database.

### BACKGROUND

An inventory management system refers to a system that monitors, tracks, and manages the stock levels, movement, and replenishment of goods, products, or components within an entity.

### BRIEF SUMMARY

In today's competitive inter-entity environment, effective inventory management is crucial for entities to maintain operational efficiency and meet customer demands. Traditionally, entities have relied on manual methods for inventory tracking and control, which often involve employees physically counting stock or manually updating inventory records in software systems. In some instances, barcode systems have been implemented to streamline these processes, allowing employees to scan items at various stages of the supply chain, such as receiving, stocking, or sales. However, while barcode systems may improve the speed and accuracy of inventory updates for individual items, they fall short in managing complex inventories that include products made up of multiple components or variations. For example, traditional systems may record the sale of a sole product but fail to account for the various components required to make that product. This gap in functionality is particularly problematic for small and medium-sized entities that lack access to more advanced enterprise resource planning (ERP) systems capable of performing sophisticated inventory management functions.

The limitations of legacy inventory management systems are numerous. First, the manual nature of these systems is highly resource-intensive, requiring significant human intervention to ensure accuracy. Employees must be physically present to conduct inventory counts or update records, leading to time-consuming and error-prone processes. Furthermore, these systems are reactive rather than proactive. For instance, stock shortages or surpluses are only identified after they occur, often resulting in missed sales opportunities or excess inventory that ties up unnecessary capital. For small entities operating with limited resources, the inefficiencies inherent in these processes can have a direct and negative impact on profitability and customer satisfaction. In addition to the time and labor costs associated with manual systems, traditional inventory management approaches are often inadequate in terms of granularity and automation. Specifically, many existing inventory management systems do not allow for the tracking of product components alongside the final product itself. For example, a restaurant that sells burgers may track the number of burgers sold but fail to account for the depletion of individual components like burger patties, buns, or condiments. This lack of visibility into component-level inventor can lead to stock shortages of critical items, interrupting entity operations and leaving customers dissatisfied. Moreover, traditional inventory management systems do not integrate real-time transaction data, meaning that inventory levels are not updated dynamically in response to transactions, which may lead to further inefficiencies. Accordingly, there exists an underlying technical necessity for systems that are able to autonomously provide these capabilities.

Example implementations described herein provide a technical solution to this technical problem. Example embodiments described herein leverage transactions that occur within a digital payment platform, or transactions imported from a universal transaction database to automatically match transactions with product categories, products, and/or product components, and update inventory stock quantities in real-time as transactions occur. One of the key advantages of this approach is that it eliminates the need for manual inventory updates by using transaction data to automate the process. Beyond real-time inventory updates, example embodiments described herein offer further advantages through its use of generative machine learning models to analyze product trends and make data-driven recommendations. This enables entities to optimize their resupply processes by ensuring that they only reorder stock when necessary, reducing the risk of overstocking or stock outs. Moreover, machine-learning driven analytics can identify patterns transaction data, providing entity representatives with insights into which products are performing well, and which may need to be discontinued or adjusted. This level of automation reduces the administrative burden on entity representatives, allowing them to focus on other critical aspects of entity operations.

By leveraging transaction data, automating inventory updates, and utilizing machine-learning driven analytics, example embodiments described herein reduce the need for manual intervention, enhance the accuracy of inventory records, and provide entities with valuable insights into their operations. The ability to track product components, generate resupply alerts, and offer tailored recommendations further distinguishes this solution as a highly effective tool for improving operational efficiency and profitability. For small entities in particular, these advantages translate into tangible benefits, such as reduced labor costs, improved stock management, and increased customer satisfaction. Furthermore, example embodiments allow for user-configured entity accounts that can be tailored to the specific offerings of the business. This allows for consideration of the individual components that make up the product rather than just the product itself. Thus, example embodiments offer flexibility to suit different operating styles and offerings.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for automation of an inventory management system.

FIG. 2 illustrates a schematic block diagram of example circuitry embodying a system device that may perform various operations in accordance with some example embodiments described herein.

FIG. 3 illustrates an example flowchart for automation of an inventory management system, in accordance with some example embodiments described herein.

FIG. 4 illustrates an example flowchart for determining, based on the product identifier, a new stock quantity for an offering associated with the configured entity account, in accordance with some example embodiments described herein.

FIG. 5 illustrates another example flowchart for causing an inventory management database to be updated to reflect the new stock quantity for the offering, in accordance with some example embodiments described herein.

FIG. 6 illustrates another example flowchart for determining the predefined threshold value for the offering, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “configured entity account” may refer to a digital profile associated with an organization that uses a digital payment platform to receive and process payments. In some embodiments, the configured entity account may be linked to the entity's bank information and may allow for the management of payments, tracking of transactions, and configuration of entity-specific settings such as product categories, inventory data, and resupply thresholds.

### System Architecture

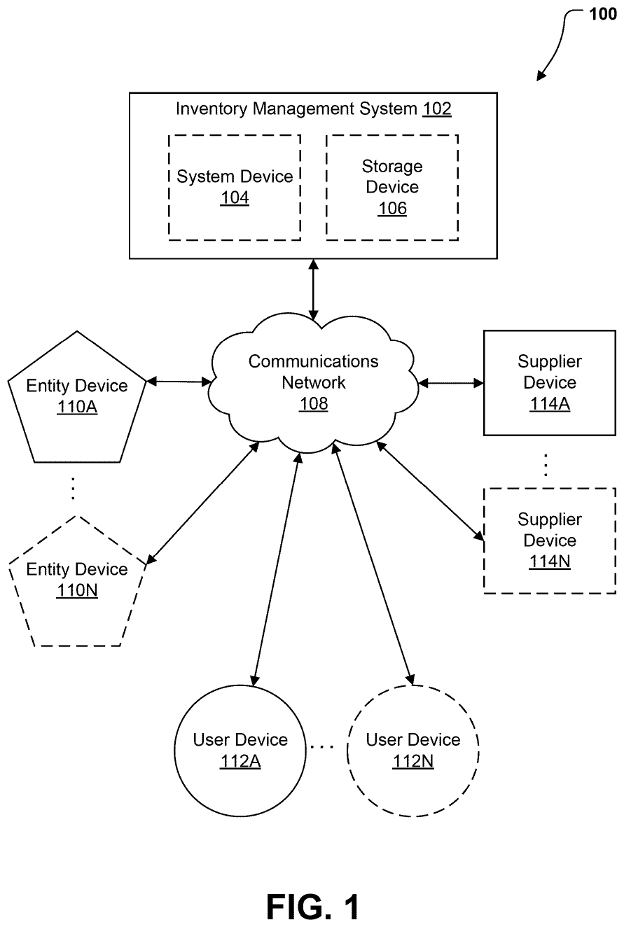

Example embodiments described herein may be implemented using any of a variety of computing devices or servers. To this end, FIG. 1 illustrates an example environment 100 within which various embodiments may operate. As illustrated, an inventory management system 102 may receive and/or transmit information via communications network 108 (e.g., the Internet) with any number of other devices, such as one or more of entity devices 110A-110N, user devices 112A-112N, and/or supplier devices 114A-114N. Although system device 104 and storage device 106 are described in singular form, some embodiments may utilize more than one system device 104, more than one storage device 106, and/or the like. The one or more entity devices 110A-110N, user devices 112A-112N, and/or supplier devices 114A-114N may be embodied by any computing devices known in the art. The one or more entity devices 110A-110N, user devices 112A-112N, and/or supplier devices 114A-114N need not themselves be independent devices but may be peripheral devices communicatively coupled to other computing devices. A user device 112A-112N may include laptops, tablets, phones, whereas an entity device 110A-110N may be a device associated with an entity (e.g., an organization) that performs operations specific to the needs of the particular entity, and a supplier device 114A-114N may be a device associated with a supplier that provides an entity with the resources required for entity-specific operations.

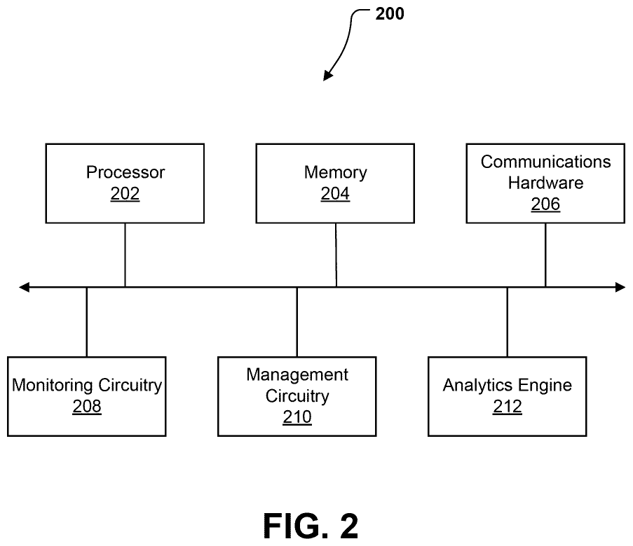

The inventory management system 102 may be implemented as one or more computing devices or servers, which may be composed of a series of components. These components of system device 104 may be physically proximate to the other components of the inventory management system 102 while other components are not. The system device 104 may receive, process, generate, and transmit data, signals, and electronic information to facilitate the operations of the inventory management system 102. Particular components of the inventory management system 102 are described in greater detail below with reference to apparatus 200 in connection with FIG. 2.

In some embodiments, the inventory management system 102 further includes a storage device 106 that comprises a distinct component from other components of the inventory management system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the inventory management system 102. Storage device 106 may store information relied upon during operation of the inventory management system 102, such as various product identifiers and analytics reports associated with an offering, data and documents to be analyzed using the inventory management system 102, or the like. In addition, storage device 106 may store control signals, device characteristics, and access credentials enabling interaction between the inventory management system 102 and one or more of the entity devices 110A-110N, user devices 112A-112N, and/or supplier devices 114A-114N.

Although FIG. 1 illustrates an environment and implementation in which the inventory management system 102 interacts indirectly with a user via one or more of entity devices 110A-110N, user devices 112A-112N, and/or supplier devices 114A-114N, in some embodiments users may directly interact with the inventory management system 102 (e.g., via communications hardware of the inventory management system 102), in which case entity devices 110A-110N, user devices 112A-112N, and/or the like may not be utilized. Whether by way of direct interaction or indirect interaction via another device, a user may communicate with, operate, control, modify, or otherwise interact with the inventory management system 102 to perform the various functions and achieve the various benefits described herein.

### Example Implementing Apparatuses

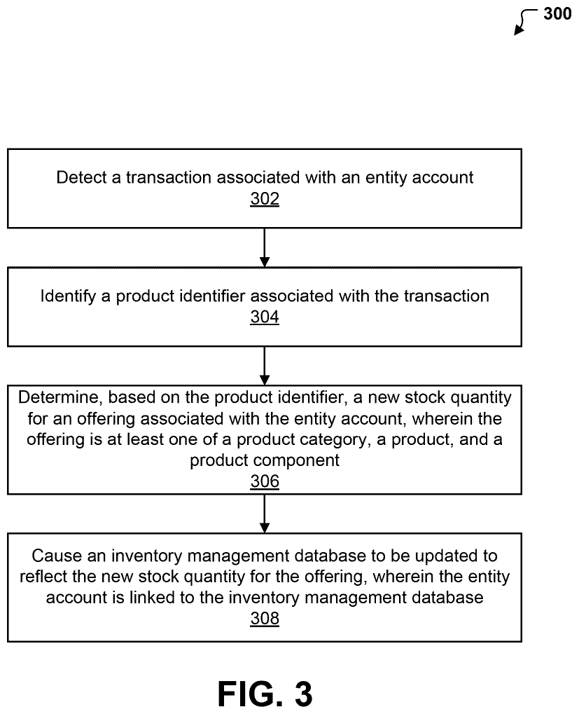

The inventory management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, monitoring circuitry 208, management circuitry 210, and analytics engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of diverse ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user, entity, and/or supplier input. In this regard, the communications hardware 206 may comprise an interface, such as a display, and may further comprise the components that govern use of the interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

The communications hardware 206 may further be configured to (i) in an instance in which the new stock quantity fails to satisfy the predefined threshold value, provide a resupply notification, wherein the resupply notification comprises a recommendation for resupplying the offering, (ii) provide an automatic resupply communication to a supplier, wherein the automatic resupply communication comprises a resupply quantity for at least one or more of one or more products and one or more product components, and (iii) retrieve a stock quantity for the offering from the inventory management database.

In addition, the apparatus 200 further comprises a monitoring circuitry 208 that detects a transaction associated with a configured entity account. The monitoring circuitry 208 may utilize processor 202, memory 204, or any other hardware component included in the apparatus 200 to perform these operations, as described in connection with FIGS. 3-6 below. The monitoring circuitry 208 may further utilize communications hardware 206 to gather data from a variety of sources (e.g., entity devices 110A-110N, user devices 112A-112N, supplier devices 114A-114N, and/or storage device 106, as shown in FIG. 1), and/or exchange data with a user, entity, and/or supplier.

In addition, the apparatus 200 further comprises management circuitry 210 that (i) identifies a product identifier associated with the transaction, (ii) determines, based on the product identifier, a new stock quantity for an offering associated with the configured entity account, (iii) causes an inventory management database to be updated to reflect the new stock quantity for the offering, wherein the configured entity account is linked to the inventory management database, (iv) determines whether the new stock quantity fails to satisfy a predefined threshold value, (v) determine the predefined value for the offering, (vi) determine a purchase quantity associated with the product identifier from the transaction, (vii) determine the new stock quantity for the offering based on the purchase quantity and the stock quantity, (viii) extracts the product identifier from the transaction, wherein the product identifier is indicative of the product and the product identifier is associated with at least one of (a) one or more product categories and (b) one or more product components, and (ix) selects the offering based on the product identifier, wherein the offering is at least one of the one or more product categories associated with the product identifier, the product indicated by the product identifier, and the one or more product components associated with the product identifier. The management circuitry 210 may utilize processor 202, memory 204, or any other hardware component included in the apparatus 200 to perform these operations, as described in connection with FIGS. 3-6 below. The management circuitry 210 may further utilize communications hardware 206 to gather data from a variety of sources (e.g., entity devices 110A-110N, user devices 112A-112N, supplier devices 114A-114N, and/or storage device 106 as shown in FIG. 1), and/or exchange data with a user, entity, and/or supplier.

Further, the apparatus 200 further comprises analytics engine 212 that (i) generates, using a generative machine learning model, the predefined threshold value for the offering, (ii) determines, using the generative machine learning model a usage pattern based on the new stock quantity, (iii) adjusts, using the generative machine learning model and based on the usage pattern, the predefined value for the offering, and (iv) generates, using a generative machine learning model, an analytics report, wherein the analytics report includes at least one of a trend, deviation, and performance metrics of the offering. The analytics engine 212 may utilize processor 202, memory 204, or any other hardware component included in the apparatus 200 to perform these operations, as described in connection with FIG. 6 below. The analytics engine 212 may further utilize communications hardware 206 to gather data from a variety of sources (e.g., entity devices 110A-110N, user devices 112A-112N, supplier devices 114A-114N, and/or storage device 106 as shown in FIG. 1), and/or exchange data with a user, entity, and/or supplier.

Although components 202-212 are described in part using functional language, it will be understood that the particular implementations necessarily include the use of particular hardware. It should also be understood that certain of these components 202-212 may include similar or common hardware. For example, the monitoring circuitry 208, management circuitry 210, and analytics engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the monitoring circuitry 208, management circuitry 210, and analytics engine 212 may leverage processor 202, memory 204, or communications hardware 206 as described above, it will be understood that any of monitoring circuitry 208, management circuitry 210, and analytics engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that monitoring circuitry 208, management circuitry 210, and analytics engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by system device 104 of the inventory management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, monitoring circuitry 208, management circuitry 210, and analytics engine 212, and/or any combination thereof. It will be understood that user interaction with the inventory management system 102 may occur directly via communications hardware 206 or may instead be facilitated by separate entity devices 110A-110N, user devices 112A-112N, supplier devices 114A-114N, as shown in FIG. 1, and which may have similar or equivalent physical componentry facilitating such user interaction.

Turning first to FIG. 3, a procedure 300 illustrates example operations for automation of an inventory management system.

In some embodiments, the procedure 300 may begin with configuration of an unconfigured entity account that has not yet been tailored to the specific inventory needs of an entity. In some embodiments, the configuration may be performed by an entity representative associated with the entity account via an entity device (e.g., any one of entity devices 110A-110N). This may require the entity representative to successfully log in to the entity account. Once logged in, the entity representative may provide input via the entity device (e.g., any one of entity devices 110A-110N) to define products, product categories, and/or product components within an account configuration interface. The entity representative may further define relationships between the products, product categories, and/or product components, such as by labelling, dragging and dropping, connecting, etc. the products, product categories, and/or product components within the account configuration interface. The analytics engine 212 may use this input to link products, product categories, and/or product components to one another.

In some embodiments, the analytics engine 212 may link the defined product with at least one a product category and/or product component based on the entity representative input. The linking process enables the entity account to categorize its inventory into manageable groupings, facilitating accurate inventory tracking and management. In some embodiments, the linking is a hierarchical linking that represents the relationship between the products, product categories, and/or product components. For example, a product category may be a top-level data object, the product may be a mid-level data object, and the product component may be a bottom-level data object. For example, a top-level product category, such as “burger”, may be linked to specific mid-level products like “cheeseburger”, and “vegan burger”, each of which may contain specific bottom-level product components, such as “buns”, “burger patties”, “lettuce”, and/or the like. By establishing these associations via the configuration process, the analytics engine 212 may configure the unconfigured entity account to ensure that it accurately reflects the unique structure and organization of the entity's inventory. In some embodiments, the analytics engine 212 may analyze transaction data, historical sales information, or patterns in inventory usage to identify optimal groupings and associations between products and their product components, allowing an entity to utilize automated tracking, restocking, and reporting processes to enable efficient inventory management, without requiring extensive manual categorization. Further, in some embodiments, the analytics engine 212, in conjunction with communications hardware 206 may prompt an entity representative to manually provide, modify, and/or verify the associations.

Once the initial configuration process is complete, the analytics engine 212 may generate a configured entity account based on the established links between product categories, products, and product components. The configured entity account may serve as an organized digital framework that stores the entity's inventory structure, enabling the entity to manage, track, and analyze inventory in real-time. By generating the configured entity account, the analytics engine 212 may effectively transition the unconfigured entity account from an unconfigured state to a customized, operational state, ready for use within the inventory management system 102.

In some embodiments, the generation of the configured entity account may also involve creating and organizing relevant metadata, such as product identifiers, category labels, and product component descriptions, which may be stored by the inventory management system 102 for future access an analysis. In particular, the structure configuration may empower the inventory management system 102 to automatically interpret transactions, categorize items accurately, and respond to changes in stock levels based on the predefined relationships established during the configuration process. Additionally, the analytics engine 212 may refine the configuration dynamically over time, ensuring that the configured entity account remains aligned with evolving inventory trends, product offerings, operational requirements, and/or the like.

As shown by operation 302, the apparatus 200 includes means such as communications hardware 206, monitoring circuitry 208, or the like, for detecting a transaction associated with a configured entity account. The communications hardware 206 may comprise a network interface (e.g., Ethernet or Wi-Fi) that connects the inventory management system 102 to the internal digital payment platform's network and external networks. In particular, the network interface enables the real-time exchange of data between a configured entity account and the transaction network. In some embodiments, the communications hardware 206 may continuously communicate with a digital payment platform's application programming interfaces (APIs) to receive transaction data associated with a transaction. Further, to ensure real-time monitoring, communications hardware 206 may utilize message queuing protocols (e.g., MQTT, AMQP) to receive push notifications for real-time transactions, without needing to poll the internal digital payment platform's network for updates. For instance, when a transaction is made via a digital payment platform, a digital payment platform's API integration layer may receive a notification in the form of a message or a data packet containing transaction data (e.g., user information, product type, transaction amount, and/or the like). In some embodiments, the notification may be received by a digital payment platform's network interface and temporarily stored in a buffer for further analysis, processing, and categorization.

The monitoring circuitry 208 is responsible for detecting incoming signals or events that indicate a transaction has occurred. In other words, the monitoring circuitry 208 continuously monitors data streams received from the communications hardware 206 and triggers the appropriate processing workflows when a valid transaction signal is detected. In some embodiments, the monitoring circuitry 208 may identify specific transaction events based on predefined characteristics (e.g., transaction signal type, data structure, metadata, etc.). In some embodiments, the monitoring circuitry 208 may process the raw signals received from the communications hardware 206 and analyze the transaction data for transaction-specific characteristics (e.g., transaction IDs, timestamps, customer data, transaction amount, etc.). In some embodiments, the monitoring circuitry 208 may use data filters to ensure only relevant signals (e.g., transaction notifications) are captured and ignore irrelevant signals.

To detect a transaction associated with a configured entity account, the monitoring circuitry 208 may continuously listen to the data streams coming from the communications hardware 206 via an established data channel (e.g., through an API), and filter out unrelated data (e.g., network noise, irrelevant signals), and may focus on detecting specific transaction signals. In some embodiments, a pattern recognition algorithm may be used to detect a transaction associated with a configured entity account. The pattern recognition algorithm may be configured with a set of rules or criteria to identify a valid transaction signal. These rules may include recognizing specific data packets or fields in the data stream that are indicative of a transaction. For example, a valid signal may contain a transaction ID, customer information, or keywords related to a product category. To identify the signal, the monitoring circuitry 208 may further use the pattern recognition algorithm to detect recognizable patterns within the incoming data, such as specific API formats or message headers from a digital payment platform. Once a valid transaction is identified, the monitoring circuitry 208 captures the entire data packet associated with the transaction signal, and this data packet may comprise all relevant transaction data such as the transaction amount, user details, and product metadata. Consider an example where a user makes a burger purchase through a digital payment platform at Burger King and sends payment to the entity via a memo “burger order with no tomato”. The communications hardware 206 may receive this transaction via the digital payment platform API and queue this as a message. Subsequently, the monitoring circuitry 208 listening to the data stream may detect the message's structure, which matches the predefined pattern of a transaction notification. The monitoring circuitry 208 may then filter the data, extracting the relevant information (e.g., product category: burger, product variation: no tomato), and may identify the order as a valid transaction signal based on the message headers and keywords.

As shown by operation 304, the apparatus 200 includes means such as communications hardware 206, management circuitry 210, or the like, for identifying a product identifier associated with the transaction. A product identifier may refer to a unique code or marker associated with a specific product category, product, and/or product component. Examples of a product identifier may include barcodes, SKU numbers, keywords, and/or the like, which may be linked to a particular product category, product, and/or product component. In some embodiments, the product identifier may be embedded within the transaction data explicitly (e.g., a barcode scanned at purchase), and/or implicitly (e.g., keywords in a memo line). Based on the nature of how the product identifier is embedded within the transaction data, various techniques may be used for identification of the product identifier.

In some embodiments, the communications hardware 206 may transmit the transaction data associated with the transaction detected by the monitoring circuitry 208 to the management circuitry 210. The management circuitry 210 may then use a signal processing unit to extract and analyze key fields in the transaction data, including potential product identifiers. In addition, the management circuitry 210 may use a data parser module to break down the extracted key fields of the transaction data into structured components. For example, if the transaction data includes a barcode or a memo line, the data parser module may extract this data for further analysis. Subsequently, the signal processing unit of the management circuitry 210 may begin its analysis to identify a product identifier using natural language processing (NLP) algorithms. In some embodiments, the inventory management system 102 may be associated with a product lookup table that links various product identifiers (e.g., barcodes, keywords, SKUs) to specific product categories, products, and product components. The signal processing unit may refer to the product look up table to map potential product identifiers identified in the transaction data to the appropriate product category, product, and/or product component. For example, a memo line of “burger with no tomato” may be matched with a “burger” product category, a “no tomato” variation, “bun, cheese, lettuce, tomato” product components, and/or the like. Alternatively, in some embodiments, if a barcode or product code is included in the transaction data, the signal processing unit may compare the barcode with entries in the product lookup table, where each barcode in the system is linked to a specific product category, product, product component, and/or other subcategories, as shown in Table 1 below.

TABLE 1
Product Lookup Table

| Product | Product Identifier |
|---|---|
| Burger - lunch product category | “123456789” |
| Burger no tomato - product | “Burger no tomato” memo |
| 2 Buns - product component | “987654321” |

In general, when the signal processing unit of the management circuitry 210 successfully identifies a product identifier, it may cross-reference with the product lookup table to validate the accuracy of its analysis. Once the product identifier has been matched with the appropriate product category in the product look up table, the management circuitry 210 may trigger the inventory management system 102 to log the product category, product, and product components as part of the transaction, which may trigger the subsequent processes described below.

In some embodiments, where the signal processing unit of the management circuitry 210 either fails to identify a product identifier or mistakenly identifies the wrong product category, product, and/or product component, the inventory management system 102 may address these potential scenarios via various error-handling mechanisms. In some embodiments, the management circuitry 210 may fail to identify any product identifier in the transaction data for reasons such as, (i) the transaction data does not contain a recognizable identifier (e.g., memo field is blank or contains unstructured data), (ii) the barcode or keyword used in the transaction data is not listed in the product look up table, (iii) there is data corruption or loss of the transaction data during transmission from the communications hardware 206 to the management circuitry 210, and/or the like. In such scenarios, the management circuitry 210 may prompt an entity representative for manual input of the product category, product, and product components associated with the transaction. For example, if the inventory management system 102 fails to identify a product from the memo line, the management circuitry 210 may trigger the communications hardware 206 to generate a prompt: “Unable to identify product. Please select the correct product category, product, and product components from the list”. In addition, the inventory management system 102 may log this failure and automatically notify a designated entity representative via an email or dashboard alert to ensure that the failure is addressed promptly, and the transaction is not left unprocessed. An example of an error log may be, “Transaction ID: 98765. Unable to identify product identifier from memo ‘burger special’. Manual intervention required”. Further, the inventory management system 102 may be programmed with fallback processing rules to handle cases where product identifiers are missing. For instance, if the memo line is blank, the management circuitry 210 may infer a default product category based on available data related to recent transactions, customer history, context, or other available metadata.

In some embodiments, where the signal processing unit of the management circuitry 210 misinterprets the transaction data and associates it with the incorrect product category, product, and/or product component, the inventory management system 102 may employ various error-handling mechanisms to address this problem. To prevent incorrect product identification, the inventory management system 102 may implement additional validation rules such as cross-checking product identifiers against recent transaction history, pricing, context, or other available metadata to ensure that the identified product category, product, and/or product component matches the transaction. For example, if a customer purchases a burger and the management circuitry 210 incorrectly identifies it as a chicken sandwich, the validation rules may flag the discrepancy if a mismatch is detected between the transaction memo “burger with no tomato” and the product category. In embodiments involving high-risk transactions (e.g., transactions involving large quantities or high-value products), the inventory management system 102 may also trigger manual verification of the product category, product, and/or product components. Additionally, the inventory management system 102 may flag any identified product that significantly deviates from normal transaction behavior. For example, if a restaurant rarely sells a particular item, but suddenly logs multiple sales of it, the inventory management system 102 may flag this transaction event for review. Further, in some embodiments, use of automated feedback loops via machine learning models may be incorporated into this particular operation of the inventory management system 102 to learn from incorrect identifications. By analyzing patterns in previous errors, a machine learning model may be used for future identification of product identifiers, in conjunction with the management circuitry 210. For instance, if the inventory management system 102 consistently misidentifies a product identifier for a particular keyword, the machine learning model may be used to improve keyword matching algorithms or prioritize barcodes over keywords for validation of certain product identifiers.

As shown by operation 306, the apparatus 200 includes means such as communications hardware 206, management circuitry 210, or the like, for determining a new stock quantity for an offering associated with the configured entity account. In some embodiments, the offering is at least one of a product category, a product, and a product component. An offering may refer to any item or service provided by an entity for sale production, delivery, and/or the like. The offering may include a full product, a category of related product, or specific components used to create the product. For example, a clothing store may have an offering that refers to a “summer collection” product category, a “shirt” product, or “blue fabric” product component used for making the shirt. A product category may refer to a grouping of similar or related products or services offered by the entity. In particular, a product category may often be organized based on the type, variation (e.g., the same item or service with different configurations or modifications), or purpose of the product to help entities manage and analyze multiple products under one umbrella. For example, a “shirt” product category may comprise several types of shirts such as t-shirts, polo shirts, long-sleeve shirts, etc. A product may refer to a specific, individual item or service the entity offers. For example, a “blue cotton t-shirt” may refer to a distinct product. A product component may refer to the individual ingredients, parts, or materials required for creation or assembly of a product. A product component may be a tangible item (e.g., fabric, thread, labels, etc.) used in the production process of the product.

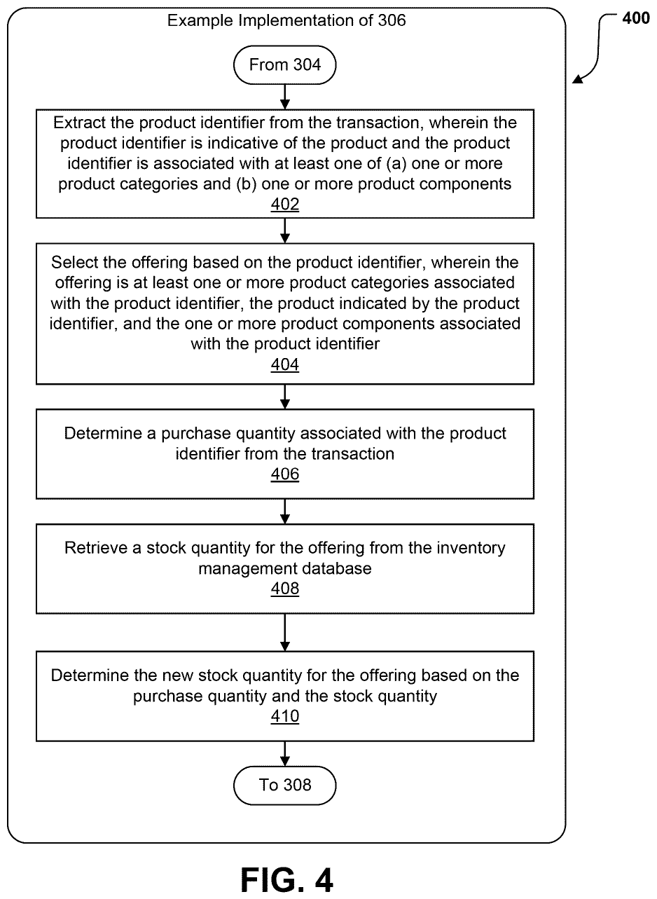

In some embodiments, operation 306 may be performed in accordance with the operations described in FIG. 4. Turning now to FIG. 4, a procedure 400 illustrates example operations for determining, based on the product identifier, a new stock quantity for an offering associated with the configured entity account, wherein the offering is at least one of a product category, a product, and a product component.

As shown by operation 402, the apparatus 200 includes means such as monitoring circuitry 208, or the like, for extracting the product identifier from the transaction. In some embodiments, the product identifier is indicative of the product and the product identifier is associated with at least one of (a) one or more product categories and (b) one or more product components. The product identifier may be extracted from transaction data associated with the transaction. In some embodiments, the transaction data may be structured data (e.g., highly organized and predefined fields like barcodes, product codes, or transaction identifiers), semi-structured data (e.g., memo lines where some information is predictable but not fully standardized), or unstructured data (e.g., in cases where the transaction metadata is not consistently formatted and exists in free-text fields or additional notes). The management circuitry 210 may identify key data fields within the transaction data based on the format of the transaction data. For example, in a digital payment platform-based transaction, the memo field may be recognized as a potential source of product information, while in an imported database transaction, item codes or lists may be the target. The management circuitry 210 may break down text fields into individual “tokens” (e.g., keywords or phrases). Tokenization is critical in handling free-text fields like memo lines, where a customer may write “cheeseburger no onions”. In this case, “cheeseburger” and “no onions” may be treated as separate tokens to be processed. In some embodiments, the management circuitry 210 may map each field of the transaction data. For structured data like barcodes, the field may be directly mapped to the corresponding product in the inventory management system 102 database. Alternatively, for semi-structured data (e.g., keywords in a memo field), the inventory management system 102 may attempt to identify patterns or common terms to map the term to the corresponding product in the inventory management system 102 database. In addition, the management circuitry 210 may clean up irrelevant or noisy data (e.g., typos, redundant characters). For instance, if the memo line reads “cheseburger” the management circuitry 210 may apply spelling correction algorithms to recognize the term as “cheeseburger” instead.

Once the transaction data is parsed as described above, the management circuitry 210 may apply pattern recognition algorithms to detect the product identifier. The specific method used depends on the type of transaction data being processed. For example, if the transaction data contains a memo line or similar free-text input, the management circuitry 210 may use a keyword matching algorithm. Examples of keyword matching algorithms include lexical matching where the management circuitry 210 compares the tokens extracted from the text to a pre-established product lookup table (PLT) which contains all known keywords associated with products, product categories, and product components. For example, if the keyword “cheeseburger” is found”, the management circuitry 210 may check the PLT to confirm whether the term corresponds to a valid product category, product, and/or product component. In addition, the management circuitry 210 may perform a synonym mapping process. For example, if the memo reads “veggie patty” the management circuitry 210 may recognize this as synonymous with the product “vegan burger” through predefined mappings between a product category, product, and product component in the PLT. In some embodiments, the management circuitry 210 may use fuzzy matching techniques for partial matches, especially when dealing with potential typos or abbreviations. For example, “cheeseburger” may still be matched to “cheeseburger” by evaluating character similarity scores between the extracted text and the expected text for a particular product category, product, and/or product component.

In some embodiments, where the transaction data is provided in a structured format (e.g., barcode), each barcode may be associated with a specific numeric or alphanumeric code that directly points to a product category, product, and/or product component. The management circuitry 210 may then directly reference the decoded barcode against the product lookup table (PLT). As each barcode may serve as a unique product identifier, this step may be particularly straightforward, linking the barcode to a product category, product, and product component. The management circuitry 210 may verify the barcode against the entity's known offerings to confirm that the barcode is valid and active.

In some embodiments, where the transaction contains unstructured text that is not immediately identifiable as a keyword or a barcode, the management circuitry 210 may use natural language processing algorithms (NLP) to extract meaningful identifiers and use contextual understanding to infer the meaning. For example, “fries” might not directly appear in the PLT, but if it is linked to a “side” product category based on past transactions, the management circuitry 210 may infer its correct meaning.

As shown by operation 404, the apparatus 200 includes means such as management circuitry 210, or the like, for selecting the offering based on the product identifier. In some embodiments, the offering is at least one of the one or more product categories associated with the product identifier, the product indicated by the product identifier, and the one or more product components associated with the product identifier. Once the management circuitry 210 extracts the product identifier from the transaction, the management circuitry 210 may cross-reference the product identifier against the product lookup table (PLT). The PLT may serve as the central repository of all valid product identifiers, along with their associations to product categories, products, and product components. For example, the barcode “12345” may refer to the product category “breakfast”, product “waffle”, and the product components of “Nutella”, “strawberries”, “50 mL waffle mix”. As an alternate example, the keyword product identifier “cheeseburger” may be linked to the “lunch” product category, “burger” product, and “patty”, “cheese”, “bun” product components.

In some embodiments, the management circuitry 210 may search the PLT for an exact match to the product identifier. If the product identifier is found, the management circuitry 210 may then retrieve the associated product category, product, and product component. If an exact match is not found, the management circuitry 210 may attempt a fuzzy match. This may be particularly useful in cases of minor variations in spelling or format. The management circuitry 210 may then use a scoring algorithm to determine the closest match within a threshold score. If no match is found, the management circuitry 210 may trigger a manual input request for clarification or assign the transaction to a default or generic category (e.g., miscellaneous).

In some embodiments, the management circuitry 210 may verify whether the extracted product identifier belongs to a valid product category. For example, “cheeseburger” may fall under both the “lunch” and “dinner” product categories. The management circuitry 210 may also check whether the product falls under known offerings of the entity to avoid false positives. If the product identifier is related to a specific product component (e.g., a patty or cheese), the management circuitry 210 may further confirm whether the product component is necessary for a particular product or product category. For instance, “patty” must be a component of the “burger” category.

In embodiments where a product identifier matches multiple product categories, products, or product components, the management circuitry 210 may use additional transactional data (e.g., pricing, past orders, customer preferences) to narrow down the exact match. For example, the management circuitry 210 may search the user order history to refine its selection of the correct offering. If a user typically orders a cheeseburger and there is a match for both “burger” and “cheeseburger,” the management circuitry 210 may prioritize the latter. In some embodiments, the management circuitry 210 may cross-check the transaction's price against known prices for the matching products. If a transaction is priced for a cheeseburger but “burger” and “veggie burger” are both possibilities, the price may help distinguish the selection of the correct product and associated product components.

As shown by operation 406, the apparatus 200 includes means such as management circuitry 210 or the like, for determining a purchase quantity associated with the product identifier from the transaction. In other words, operation 406 involves identifying the number of units for a given product category, product, and/or product component that were included in the transaction. The management circuitry 210 may parse the transaction data to determine the purchase quantity associated with the product identifier from the transaction. This information may be sourced from several sources within the transaction data such as itemized lists. For example, if the transaction includes an itemized list of products, each product may be associated with a specific purchase quantity (e.g., cheeseburger×2, or burger patty (5 units) in an itemized transaction or receipt. In embodiments where the quantity is not clearly structured (e.g., a memo line in a digital payment platform), the management circuitry 210 may determine the purchase quantity from text by parsing phrases like “2 burgers” or “5 orders of fries”.

For structured transactions (e.g., from a point-of-sale system), the management circuitry 210 may directly determine the purchase quantity by reading predefined fields that correspond to each product's count. This may include standard data fields such as quantity, number of items, or units.

For semi-structured or unstructured data (e.g., memo fields or notes), the management circuitry 210 may employ natural language processing techniques to recognize quantities expressed in text form. For example, in the memo line “2 cheeseburgers, 1 small fry”, NLP algorithms may detect the numbers “2” and “1” as the purchase quantity associated with “cheeseburgers” and “small fry”, respectively. In some embodiments, the management circuitry 210 may also use pattern recognition algorithms for phrases like “pair”, “dozen”, or “half” to determine purchase quantities for the product identifier that are not expressed numerically.

Once the purchase quantity is determined from the transaction data, the management circuitry 210 may map the purchase quantity to the corresponding product identifier that was detected earlier. This mapping ensures that the correct product category, product, and/or product component are linked to the identified purchasing quantity.

In some embodiments, where multiple product identifiers are present in a single transaction (E.g., “meal combo×2”, wherein a meal combo consists of a burger, fries, and soda), the management circuitry 210 may recognize that both the burger, fries, and soda products each have a purchase quantity of two. Additionally, the management circuitry 210 may identify the product components associated with a particular product (e.g., product components for a burger may be 2 buns, 1 patty, and 1 cheese slice) and may infer the purchase quantity for the product component based on the purchase quantity of the product. For example, the management circuitry 210 may infer that a purchase of “2 burgers” is associated with a purchase quantity of 4 buns, 2 patties, and 2 cheese slices.

In some embodiments, where the management circuitry 210 is unable to determine the purchase quantity due to conflicting or unclear information in the transaction data, the management circuitry 210 may prompt the entity representative to manually input or confirm the purchase quantity. In some embodiments, where the management circuitry 210 is unable to determine the purchase quantity from the transaction data due to missing information, the management circuitry 210 may make a default quantity assumption of one. For example, if the memo line for a receipt says “cheeseburger”, but no quantity is specified, the management circuitry 210 may assume the user purchased one unit. In some embodiments, where the management circuitry 210 detects unusually large or nonsensical quantities (e.g., “cheeseburger×1000”) in a small transaction, the management circuitry 210 may flag the transaction as requiring review and may either adjust the quantity after asking an entity representative to confirm the purchase quantity. In some embodiments, if a transaction involves bulk purchases (e.g., 100 burger patties”), the management circuitry 210 may treat the purchase quantity as an aggregate and may map the transaction directly to the product component. In other embodiments, where a transaction represents a return or refund, the management circuitry 210 may interpret the quantity as a negative purchase quantity. For example, if a customer returns “2 shirts”, the management circuitry 210 may add 2 units of “shirts” back to the inventory database.

As shown by operation 408, the apparatus 200 includes means such as communications hardware 206, management circuitry 210, or the like, for retrieving a stock quantity for the offering from the inventory management database. In particular, operation 408 is focused on accessing the current stock level for the offering (e.g., product category, product, product component) to enable inventory updates. The management circuitry 210 may use the product identifier to query the product lookup table (PLT) within the inventory management database. Based on the nature of the offering (e.g., product category, product, and/or product component), the management circuitry 210 may select the correct offering from the PLT and may transmit a query to the inventory management database to retrieve the current stock quantity for the particular offering. In some embodiments, the management circuitry 210 may formulate a query based on the product identifier and the offering item. In particular, the query may be structured to retrieve specific fields related to stock quantity, such as: (i) current stock quantity (i.e., the number of units currently available for a product category, product, and/or product component), (ii) restock threshold (i.e., the minimum number of units before a resupply alert may be triggered, (iii) safety stock level (i.e., the buffer quantity used to prevent stockouts in case of unexpected demand), and/or the like. The management circuitry 210 may formulate a query such as: SELECT current_stock_quantity FROM inventory WHERE product_identifier=‘Cheeseburger’, and the communications hardware 206 may transmit this query to the inventory management database to receive a result that provides the current stock quantity for the offering. For example, the communications hardware 206 may retrieve the value “45” for “cheeseburger” as being the current stock quantity. In some embodiments, if an offering involves multiple product components (e.g., ingredients like burger patty and cheese), the system may retrieve stock quantities for each associated product component. For example, the communications hardware 206 may retrieve stock quantities such as “90 buns” and “50 patties” as the product component stock quantity for a “cheeseburger” product.

In some embodiments, the management circuitry 210 may validate the retrieved stock quantity for the offering by checking for any anomalies such as negative quantities or inconsistent data. For instance, the management circuitry 210 may check for inconsistencies between the product and the product components. For example, if the “cheeseburger” product has 45 units but the “patty” product component only has 10 units, the management circuitry 210 may flag this discrepancy.

In some embodiments, if the management circuitry 210 detects errors (e.g., missing or inconsistent data), the management circuitry 210 may trigger error handling procedures which may involve re-querying the inventory management database to correct missing data, using default stock quantities if a stock quantity cannot be retrieved (e.g., zero), logging the error and alerting an entity representative for manual correction of the stock quantity, and/or the like.

As shown by operation 410, the apparatus 200 includes means such as management circuitry 210 or the like, for determining the new stock quantity for the offering based on the purchase quantity and the stock quantity. The management circuitry 210 may determine the new stock quantity for the offering by subtracting the purchase quantity from the current stock quantity. The management circuitry 210 may ensure that the both the current stock quantity and the purchase quantity are whole numbers to prevent erroneous results. Further, the management circuitry 210 may determine the new stock quantity for the product components associated with the product, by subtracting the purchase quantity of the product components from the current component stock quantity.

Returning to FIG. 3, as shown by operation 308, the apparatus 200 includes means such as communications hardware 206, management circuitry 210, or the like, for causing an inventory management database to be updated to reflect the new stock quantity for the offering, wherein the configured entity account is linked to the inventory management database. Once the new stock quantity has been determined for the offering (e.g., product category, product, and/or product component), the management circuitry 210 may ensure that the new stock quantity is updated in the inventory management database to keep the inventory records up to date. In some embodiments, the management circuitry 210 may package the new stock quantity in a format compatible for input into the inventory management database. For instance, the management circuitry 210 may associated the new stock quantity with the appropriate offering to ensure that the inventory management database updates to the correct offering. For example, a new stock quantity of 42 for “cheeseburger” may be linked to the specific product identifier for “cheeseburger” in the inventory management database. The prepared data packet may resemble the following:
Configured entity account ID: Restaurant A
Offering/Product Identifier: CHEESEBURGER_001-12345
New Stock Quantity: 42
   The management circuitry 210 may then initiate communication with the inventory management database via the communications hardware 206. The communications hardware 206 may use various networking protocols such as TCP/IP to ensure reliable data transfer between the management circuitry 210 and the inventory management database, and may also use database connection protocols (ODBC, JDBC, or REST APIs), depending on the architecture of the inventory management database. In some embodiments, the communications hardware 206 may further manage authentication of the configured entity account using entity credentials (e.g., configured entity account login or API keys) to ensure that only authorized updates to the stock quantity are made. Once the connection is established, the communications hardware 206 may transmit an update command that may contain inventory management database details (e.g., the appropriate table(s) and field(s) within the inventory management database that store the stock quantities), the specific SQL or NoSQL commands used to update the stock data, transaction mechanisms that ensure that the update is fully completed or rolled back if any errors occur during the transmission process (e.g., the communications hardware 206 may initiate a database transaction to ensure the update operation either succeeds entirely or fails without leaving the inventory management database in an inconsistent state). In addition, the communications hardware may perform validation checks to ensure that the new stock quantity data being transmitted is valid. For instance, the communications hardware 206 may verify that the new stock quantity is a non-negative number, that the offering/product identifier exists in the database, and that the configured entity account is correctly linked to the offering. Once the inventory management database processes the update command, the communications hardware 206 may receive a confirmation response from the inventory management database indicating whether the stock quantity update was successful. If any issues arose (e.g., network failure, database timeout, invalid data), the communications hardware 206 may receive an error message.

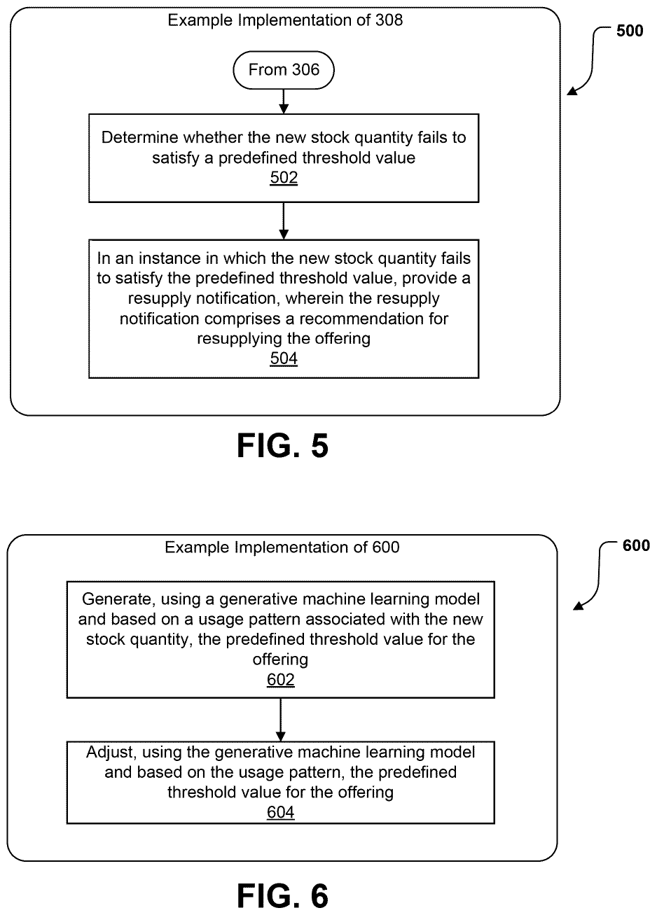

Turning now to FIG. 5, a procedure 500 illustrates example operations for causing an inventory management database to be updated to reflect the new stock quantity for the offering.

As shown by operation 502, the apparatus 200 includes means such as management circuitry 210, or the like, for determining whether the new stock quantity fails to satisfy a predefined threshold value. The predefined threshold value may be set by an entity representative or may be automatically determined by a generative machine learning model based on historical data and trends, as described in operations 602-604. The management circuitry 210 may trigger the communications hardware 206 to transmit a query to retrieve the predefined threshold value for a particular offering. The management circuitry 210 may then perform a comparison of the new stock quantity against the predefined threshold value. In cases where the new stock quantity is less than or equal to the predefined threshold value, this may indicate that the stock quantity has fallen below an acceptable level. If the new stock quantity is greater than the predefined threshold value, this may indicate that the stock quantity meets or surpasses the expected level.

In some embodiments, if the predefined threshold value is missing or is not configured for a particular offering, the management circuitry 210 may use a default threshold defined for all offerings, and/or may trigger an alert to an entity representative to manually set a threshold for the particular offering.

In some embodiments, the management circuitry 210 may determine a predefined threshold for the offering. In particular, as described further in FIG. 6, the management circuitry 210 may determine a predefined threshold by leveraging a generative machine learning model that is configured to leverage usage patterns. In doing so, the predefined threshold is a dynamic value that is customized for the particular configured entity account.

As shown by operation 504, the apparatus 200 includes means such as communications hardware 206, management circuitry 210, or the like, for in an instance in which the new stock quantity fails to satisfy the predefined threshold value, providing, by communications hardware, a resupply notification. In some embodiments, the resupply notification comprises a recommendation for resupplying the offering. Once the new stock quantity for an offering is determined, the management circuitry 210 may compare this quantity against the predefined threshold value stored in the inventory management database. This process may be continuous to track stock quantities in real-time as transactions are processed. For instance, if the current stock of burger patties is determined to be 15 units and the predefined threshold value is 20 units, the management circuitry 210 may identify a shortfall.

In some embodiments, the management circuitry 210 may immediately detect that the new stock quantity is lower than the predefined threshold value and may flag this condition to trigger the resupply mechanism. For generating a resupply notification, the communications hardware 206 may raise an alert, indicating that stock levels for a particular offering (e.g., burger patties) have fallen below acceptable limits. The communications hardware 206 may transmit the resupply notification to an entity representative via wireless transceivers (Wi-Fi, Bluetooth, LTE/5G), email/SMS servers, mobile or web application interface, and/or the like.

The resupply notification may include elements such as detail of the offering (e.g., the product or product component that is below the threshold), the current stock quantity, the predefined threshold value, and the shortfall alert (e.g., stock for burger patties is below the predefined threshold value of 20 units).

In some embodiments, the management circuitry 210 may use machine-learning driven analytics to provide a recommendation for resupplying the offering. This recommendation may be tailored based on several factors such as historical demand, usage patterns, upcoming events, or expected future sales. In some embodiments, the recommendation may include the recommended resupply quantity (e.g., the suggested quantity to order based on recent demand and future projections), vendor information, and/or the like. Additionally, in some embodiments, the entity representative may customize the recommended quantity or override the recommended quantity before placing the order and may be prompted to approve the resupply notification manually.

In some embodiments, the management circuitry 210 may automatically provide, by communications hardware, an automatic resupply communication to a supplier, wherein the automatic resupply communication comprises a resupply quantity for at least one or more of (i) one or more products and (ii) one or more product components. In some embodiments, the communications hardware 206 may generate a purchase order for the recommended quantity or trigger an order placement with the relevant vendor or supplier. The automatic resupply communication may include details for placing the order with the supplier, such as supplier information (e.g., predefined contact details—email address, API endpoint, phone number), product details (e.g., product identifiers for the products or components that need to be restocked), resupply quantity (e.g., the calculated number of units that should be ordered to replenish stock), and/or the like. In some embodiments, the communication packet may be structured according to the supplier's preferred format in the form of an email, API request, electronic data interchange (EDI), and/or the like. In some embodiments, upon transmission of the automatic resupply notification, the communications hardware 206 may also monitor for an order confirmation from the supplier, ensuring that the order has been successfully received and processed. In addition, the communications hardware 206 may update the inventory management database to highlight the pending resupply quantities to help the entity monitor incoming stock quantities and over-ordering for a particular product and/or product component.

Turning now to FIG. 6, a procedure 600 illustrates example operations for determining the predefined threshold value for the offering.

As shown by operation 602, the apparatus 200 includes means such as analytics engine 212 or the like, for generating the predefined threshold value for the offering. In particular, this operation leverages a machine learning model to dynamically calculate and/or adjust a predefined threshold value for the offering based on historical and contextual data. As the generative machine learning model requires a variety of input data to determine the most appropriate threshold value for the offering, the generative machine learning model may analyze trends, patterns, and deviations in stock levels, sales, and other relevant data over time. The following data may be collected and inputted into the generative machine learning model: (i) historical sales data—how often the product or the product components are sold over time (e.g., sales volume per day, week, or month), (ii) seasonal trends—patterns that occur at certain times of the year that affect demand (e.g., holidays, weekends, or promotional events), (iii) restocking patterns—how often the entity restocks products and product components, and how quickly they are consumed, (iv) supplier information—delivery lead times and reliability of suppliers that affect how quickly stock can be replenished, (v) inventory turnover rates (i.e., usage pattern)—the rate at which inventory is used or sold, which influences how quickly stock quantities fluctuate, (vi) entity-specific parameters (e.g., budget constraints or storage limitations that may impact how much inventory the entity is willing or able to hold). In some embodiments, the communications hardware 206 may interface with various internal systems (e.g., sales software, supplier databases, and historical transaction logs) to collect the relevant data to be provided to the generative machine learning model.

As the data is inputted into the machine learning model, the data may undergo preprocessing and feature engineering to ensure that the data is structured and relevant for generation of the predefined threshold value. Preprocessing may include handling missing data, normalizing values, converting categorical data (e.g., product categories, sales regions) into usable features for the model. For example, if a restaurant has inconsistent data for some time periods (e.g., due to a system downtime), the generative machine learning model may use interpolation to fill gaps. In particular, the generative machine learning model may create additional inputs based on the raw data, such as sales velocity, seasonal adjustment factors, supplier lead time adjustments, and/or the like.

In some embodiments, the generative machine learning model may be a generative adversarial network (GAN) where one neural network proposes threshold values, and another neural network evaluates how reasonable these generated values are based on historical data. Alternatively, the generative machine learning model may be a Bayesian network that generates the predefined threshold value based on probabilities derived from historical trends and deviations. In other embodiments, the generative machine learning model may use a recurrent neural network to handle time series data and predict future inventory needs based on analysis of the historical inventory fluctuations over time.

Once the data is preprocessed and inputted into the generative machine learning model, the management circuitry 210 may trigger the generative machine learning model to generate a recommended threshold value for the offering. In some embodiments, the generative machine learning model may process the input data and may generate a prediction of what the optimal threshold value should be based on historical trends and expected future demand. For example, based on the past six months of cheeseburger sales, the generative machine learning model may predict that the optimal threshold value for burger patties should be 6—during summer months, as sales spike during that particular season. In alternate embodiments, the generative machine learning model may generate multiple threshold values and select the threshold value that maximizes certain objectives, such as minimizing the risk of stockouts while avoiding overstock. For instance, the generative machine learning model may predict that setting a threshold value that is too low increases the risk of stockouts, while setting it too high increases storage costs.

Upon generation of the threshold value, the management circuitry 210 may evaluate the result by performing a validation check. For instance, the proposed threshold may be checked against business rules (e.g., ensuring it does not exceed storage capacity or budget constraints). In addition, entity representatives may be notified of the proposed threshold and have the option to manually adjust it if needed. For example, the generative machine learning model may suggest a threshold value of 60 burger patties, but the entity specific representative may override the threshold value to 50 patties due to limited freezer space.

In some embodiments, the generative machine learning model may be configured to generate an analytics report, wherein the analytics report includes at least one of a trend, deviation, and performance metrics of the offering. In some embodiments, the generative machine learning model may analyze historical data to identify consistent patterns. These trends may be projected forward in time to give the entity insight into future behavior. Examples of trends may include sales growth/decline (e.g., whether sales of a product are consistently rising or falling), seasonal effects (e.g., peaks in demand that coincide with specific seasons, holidays, or external events), inventory usage (e.g., how quickly inventory is depleted over time), and/or the like. For instance, the generative machine learning model may detect that sales of hamburgers increase by 15% during the summer months, indicating a seasonal demand trend.

In some embodiments, the generative machine learning model may identify deviations from established trends. This may involve flagging anomalies or outliers in the data that could indicate potential issues, opportunities, or unexpected shifts in behavior. Examples of deviation may include sudden sales spikes/drops (e.g., a sudden drop in sales for a product that is normally consistent may indicate a supply issue or a competitor's promotion), stock shortages/surpluses (e.g., anomalies in inventory data, where a product is either overstocked or understocked based on typical patterns), and/or the like. For instance, the generative machine learning model may identify a sudden dip in hamburger sales during a normally high-demand week, which may signal a competitor's promotional campaign.

In some embodiments, the generative machine learning model may identify performance metrics—quantitative measures that reflect how well the offering (product or component) performs relative to expectations. Examples of this may include sales metrics (e.g., total units sold, average revenue per product), inventory metrics (e.g., stock turnover rate, time to replenish stock), supplier metrics (e.g., on-time delivery rate, order accuracy), and/or the like. For instance, the generative machine learning model may calculate that the turnover rate for hamburger buns is faster than the turnover for patties, suggesting that the entity needs to optimize the reordering schedule for buns.

Once the analytics are generated, the analytics engine 212 may organize the generated analytics into an analytics report. In some embodiments, the analytics report may be delivered through a digital dashboard or a downloadable document. In particular, the analytics report may be divided into several sections, each focused on a specific aspect of the offering's performance: (i) trends overview—a summary of key trends observed in sales, inventory levels, or product demand (e.g., cheeseburger sales have increased by 10% each month over the past year), (ii) deviations section—a list of any significant deviations from historical patterns or expected values (e.g., there was a 20% drop in cheeseburger sales last month, likely due to a local competitor's promotional discount), (iii) performance metrics—specific metrics that provide a snapshot of how well the product or component is performing (e.g., the average inventory turnover rate for cheeseburger patties is 3 days, and the average stockout rate is 0.5%), (iv) predictions and forecasts—future sales or inventory projections, based on identified trends (e.g., projected cheeseburger sales for the next quarter are 5000 units, with a 95% confidence interval), and/or the like.

In some embodiments, the analytics report may include visual representations of the data such as line charts (e.g., showing sales growth over time), heat maps (e.g., indicating seasonal demand spokes), bar graphs (e.g., displaying the comparison of stock levels for various products). In some embodiments, the analytics report may include machine learning driven recommendations based on the analysis. For example, inventory adjustments such as increasing the order frequency for hamburger buns to avoid stockouts, and product portfolio adjustments such as removing cheeseburgers without pickles from the menu as they only account for 2% of sales. In some embodiments, once the analytics report is generated, it may be delivered to the entity representative via the communications hardware 206 as an email, through a dashboard, or through a mobile app linked to the inventory management system 102.

As shown by operation 604, the apparatus 200 includes means such as communications hardware 206, analytics engine 212 or the like, for adjusting the predefined threshold value for the offering. In particular, the analytics engine may adjust the predefined threshold based on the usage pattern. In some embodiments, the analytics engine 212 may automatically update the inventory management database to reflect the threshold value. In addition, the analytics engine 212 may notify entity representatives to reflect this change. The most streamlined approach may include the analytics engine 212 noting the threshold value into the relevant fields of the inventory management database. For example, if the threshold value for burger buns has increased from 50 to 80, the analytics engine 212 may update the inventory management database entry associated with the “burger bun” product component to set the new threshold at 80 units.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved inventory management. Example embodiments thus provide tools that overcome the problems faced by traditional and manual inventory tracking systems, which are often resource-intensive, error-prone, and lack real-time responsiveness. For example, by avoiding the need to manually perform evaluations of inventory, example embodiments save time and resources while also eliminating the possibility of human error that has been unavoidable in the past. This automation enhances both the accuracy and efficiency of inventory management, which is particularly critical for small and medium-sized entities that may lack the resources to implement more complex enterprise solutions.

Moreover, embodiments described herein avoid the delays and inaccuracies typically associated with manual stock monitoring and replenishment. The automation of processes such as tracking product components, updating stock levels, and generating resupply alerts ensures that entities can maintain optimal stock levels without the need for constant oversight. For example, by automating functionality that has historical required human intervention, the speed and consistency of the evaluations performed by example embodiments unlock many potential new functions that have historically not been available, such as the ability to conduct near real-time inventory updates and resupply operations based on transaction data. This is particularly advantageous for entities that experience fluctuating demand, as the example embodiments described herein can quickly adapt to changing stock needs without the risk of running out of critical components.

Additionally, the integration of a generative machine learning model allows for the analysis of historical sales data and the prediction of future trends, enabling entities to optimize their inventory management processes further by adjusting resupply thresholds dynamically, forecasting demand, and making strategic decisions about product offerings based on consumer behaviors. The machine-learning driven analytics can provide insights into product performance, such as identifying top-selling items or underperforming products, which can help businesses refine their inventory and offerings to better meet market demands. These predictive capabilities demonstrate a significant improvement over traditional inventory systems, which often only provide a static snapshot of stock levels without offering actionable insights.

And while inventory management has been an issue for decades, the demand for real-time, accurate, and automated inventory management has grown significantly, while the complexity of managing multi-component and product-category-based inventory has itself increased. The increasing complexity of product offerings, such as multiple variations of a specific product or the use of product components, adds further challenges to inventory management that traditional inventory management systems are ill-equipped to handle. Example embodiments contemplated herein provide technical solutions that solve these real-world problems faced during inventory tracking, stock management, and supply chain operations, allowing for more intelligent, responsive, and scalable inventory management, reduction of entity operation costs, and improvement of overall entity efficiency.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for automation of an inventory management system, the method comprising:
linking, by analytics engine, (a) a product with one or more product categories and (b) the product with one or more product components, within a configured entity account;
detecting, by monitoring circuitry, a transaction over a digital payment platform associated with the configured entity account;
identifying, by management circuitry, a product identifier associated with the transaction, wherein the product identifier identifies the product;
determining, by the management circuitry and based on the product identifier, a new stock quantity for an offering associated with the configured entity account, wherein the offering is at least one of the one or more product categories, the product, and the one or more product components; and
causing, by the management circuitry, an inventory management database to be updated to reflect the new stock quantity for the offering, wherein the configured entity account is linked to the inventory management database.

2. The method of claim 1, further comprising:
determining, by the management circuitry, whether the new stock quantity fails to satisfy a predefined threshold value; and
in an instance in which the new stock quantity fails to satisfy the predefined threshold value, providing, by communications hardware, a resupply notification, wherein the resupply notification comprises a recommendation for resupplying the offering.

3. The method of claim 2, further comprising determining, by the management circuitry, the predefined threshold value for the offering.

4. The method of claim 3, further comprising generating, by the analytics engine and using a generative machine learning model, and based on a usage pattern associated with the new stock quantity, the predefined threshold value for the offering.

5. The method of claim 4, further comprising:
determining, by analytics engine and using the generative machine learning model, the usage pattern based on the new stock quantity; and
adjusting, by the analytics engine and using the generative machine learning model, and based on the usage pattern, the predefined threshold value for the offering.

6. The method of claim 1, further comprising providing, by communications hardware, an automatic resupply communication to a supplier, wherein the automatic resupply communication comprises a resupply quantity for at least one or more of (i) the product and (ii) the one or more product components.

7. The method of claim 1, further comprising:
determining, by the management circuitry, a purchase quantity associated with the product identifier from the transaction;
retrieving, by communications hardware, a stock quantity for the offering from the inventory management database; and
determining, by the management circuitry, the new stock quantity for the offering based on the purchase quantity and the stock quantity.

8. The method of claim 1, further comprising:
extracting, by the management circuitry, the product identifier from the transaction, wherein the product identifier is indicative of the product and the product identifier is associated with at least one of (a) the one or more product categories and (b) the one or more product components; and
selecting, by the management circuitry, the offering based on the product identifier, wherein the offering is at least one of the one or more product categories associated with the product identifier, the product indicated by the product identifier, and the one or more product components associated with the product.

9. The method of claim 1, further comprising generating, by the analytics engine and using a generative machine learning model, an analytics report, wherein the analytics report includes at least one of a trend, deviation, and performance metrics of the offering.

10. An apparatus for automation of an inventory management system, the apparatus comprising:
analytics engine configured to link (a) a product with one or more product categories and (b) the product with one or more product components, within a configured entity account;
monitoring circuitry configured to detect a transaction over a digital payment platform associated with the configured entity account; and
management circuitry configured to:
identify a product identifier associated with the transaction, wherein the product identifier identifies the product,
determine, based on the product identifier, a new stock quantity for an offering associated with the configured entity account, wherein the offering is at least one of the one or more product categories, the product, and the one or more product components, and
cause an inventory management database to be updated to reflect the new stock quantity for the offering, wherein the configured entity account is linked to the inventory management database.

11. The apparatus of claim 10, wherein the management circuitry is further configured to determine whether the new stock quantity fails to satisfy a predefined threshold value,
wherein the apparatus further comprises communications hardware configured to, in an instance in which the new stock quantity fails to satisfy the predefined threshold value, provide a resupply notification, wherein the resupply notification comprises a recommendation for resupplying the offering.

12. The apparatus of claim 11, wherein the management circuitry is further configured to determine the predefined threshold value for the offering.

13. The apparatus of claim 12, wherein the analytics engine is further configured to generate, using a generative machine learning model, and based on a usage pattern associated with the new stock quantity, the predefined threshold value for the offering.

14. The apparatus of claim 13, wherein the analytics engine is further configured to:
determine, using the generative machine learning model, the usage pattern based on the new stock quantity; and
adjust, using the generative machine learning model, and based on the usage pattern, the predefined threshold value for the offering.

15. The apparatus of claim 10, further comprising communications hardware configured to:
provide an automatic resupply communication to a supplier, wherein the automatic resupply communication comprises a resupply quantity for at least one or more of (i) one or more products and (ii) the one or more product components.

16. The apparatus of claim 10, wherein the management circuitry is further configured to determine a purchase quantity associated with the product identifier from the transaction,
wherein the apparatus further comprises communications hardware configured to retrieve, a stock quantity for the offering from the inventory management database,
wherein the management circuitry is further configured to determine the new stock quantity for the offering based on the purchase quantity and the stock quantity.

17. The apparatus of claim 10, wherein the management circuitry is further configured to:
extract the product identifier from the transaction, wherein the product identifier is indicative of the product and the product identifier is associated with at least one of (a) the one or more product categories and (b) the one or more product components; and
select the offering based on the product identifier, wherein the offering is at least one of the one or more product categories associated with the product identifier, the product indicated by the product identifier, and the one or more product components associated with the product identifier.

18. The apparatus of claim 10, wherein the analytics engine is further configured to generate, using a generative machine learning model, an analytics report, wherein the analytics report includes at least one of a trend, deviation, and performance metrics of the offering.

19. A computer program product for automation of an inventory management system, the computer program product comprising at least one non-transitory computer readable storage medium storing software instructions that, when executed cause an apparatus to:
detect a transaction over a digital payment platform associated with a configured entity account;
identify a product identifier associated with the transaction;
determine, based on the product identifier, a new stock quantity for an offering associated with the configured entity account, wherein the offering is at least one of a product category, a product, and a product component; and
cause an inventory management database to be updated to reflect the new stock quantity for the offering, wherein the configured entity account is linked to the inventory management database.

20. The computer program product of claim 19, wherein the software instructions, when executed, further cause the apparatus to:
determine whether the new stock quantity fails to satisfy a predefined threshold value; and
in an instance in which the new stock quantity fails to satisfy the predefined threshold value, provide a resupply notification, wherein the resupply notification comprises a recommendation for resupplying the offering.
